(19) United States
(12) Patent Application Publication
(10) Pub. No.: US 2009/0158150 A1
(43) Pub. Date: Jun. 18, 2009

(54) RULES-BASED PROFILE SWITCHING IN METAVERSE APPLICATIONS

(75) Inventors: Ruthie D. Lyle, Durham, NC (US); Angela Richards Jones, Durham, NC (US); Fuyi Li, Sudbury, MA (US); Vandana Mallempati, Austin, TX (US); Pamela A. Nesbitt, Tampa, FL (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/958,794

(22) Filed: Dec. 18, 2007

(51) Int. Cl. G06F 3/048

(52) U.S. Cl. 715/706

(57) ABSTRACT

A method is disclosed for providing gameplay in a metaverse application in which players interact with each other and a virtual world by controlling characters that are represented using avatars specified by avatar profiles. The method comprises providing a player with an ability to specify and maintain more than one avatar profile for a character controlled by the player; and allowing an avatar representation of the character to be switched between the more than one avatar profile during gameplay.

### BACKGROUND OF THE INVENTION

1. Field of the Invention

Exemplary embodiments of the present invention relate to computer-based virtual worlds, and more particularly, to the use of avatars in virtual worlds.

2. Description of Background

In recent years, persistent virtual worlds that are accessible to multiple subscribers over a network have become very popular. A virtual world is a computer-based simulated environment intended for its users to inhabit, interact with, and explore. This habitation usually is represented in the form of two or three-dimensional graphical representations of humanoids, or other graphical or text-based representations known as avatars. Most, but not all, virtual worlds allow for multiple users. For example, hundreds of thousands of players access games known as massive multi-player online games (MMOGs) in which all players may interact with each other at any given time. MMOGs can enable players to cooperate and compete with each other on a grand scale, and sometimes to interact meaningfully with people around the world. Players of these games customarily access a game repetitively (for durations typically ranging from a few minutes to several days) over given period of time, which may be days, months, or even years. The games are often implemented such that players pay a periodic subscription price (for example, $15 per month) rather than, or in addition to, paying a one time purchase price for the game. Often, though not necessarily, these games have no ultimate “winner” or “winning goal,” but instead attempt to create an enjoyable playing environment and a strong player community.

The term avatar refers to a player's representation of himself or herself, whether in the form of a three-dimensional model used in computer games, a two-dimensional icon (picture) used on Internet forums and other communities, or a text construct found on early multi-player computer games. An avatar in a virtual environment essentially provides the representation of a player's character's appearance in the virtual world on a video screen. In most games, the player's representation is fixed. Increasingly, however, games offer a basic character model, or template, and then allow customization of the physical features as the player sees fit. For example, a game may provide for a player's avatar to be dressed in a wide range of clothing, given tattoos and haircuts, and able to body build or become obese depending upon player actions. Avatars in virtual environments can provide for a virtual experience that is similar to real-life face to face communication, such as through facial expressions and body language cues.

Virtual communities such as Linden Lab's “Second Life” provide a three-dimensional metaverse world in which players interact with each other (socially and economically), the local environment, and with software agents using virtual characters in a cyber space. A metaverse provides a persistent virtual world built on coding protocols that use the metaphor of the real world without its physical limitations to define what can and cannot be done in the virtual world. The players may be required to pay a fee for the right to access the metaverse or to engage in other optional interactions (for example, buying an object or attending an event) in the metaverse. The degree of interaction between the players and the virtual world is implemented by one or more computer applications that govern such interactions as simulated physics, exchange of information between players, and the like. Player participation can be driven by, for example, social, artistic, and commercial motivations. The nature of interactions among players in the virtual world is often limited by the constraints of the system implementing the virtual world. Player's avatars in metaverses are typically provided as two-dimensional or three-dimensional human or fantastic representations of a person's self. Player can explore and interact with the metaverse they are in using their avatar, add to it, or conduct conversations with other players, and can be customized by the player. For example, in Second Life, avatars are created by players and can range from lifelike humans to more fanciful robots, animals, and mythical creatures. Nevertheless, in currently available metaverse applications that provide persistent virtual worlds, the information used to describe the avatar representation of a character being controlled by a player in a virtual world is specified in a unitary and fixed profile to which only incremental changes are permitted. As a result, when a player desires to have a noteworthy change made to the avatar representation of his or her character in the virtual world, the process can be tedious and time-consuming.

### SUMMARY OF THE INVENTION

The shortcomings of the prior art can be overcome and additional advantages can be provided through exemplary embodiments of the present invention that are related to a method for providing gameplay in a metaverse application in which players interact with each other and a virtual world by controlling characters that are represented using avatars specified by avatar profiles. The method comprises providing a player with an ability to specify and maintain more than one avatar profile for a character controlled by the player; and allowing an avatar representation of the character to be switched between the more than one avatar profile during gameplay.

The shortcomings of the prior art can also be overcome and additional advantages can also be provided through exemplary embodiments of the present invention that are related to computer program products and data processing systems corresponding to the above-summarized method are also described herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution that can be implemented within a metaverse application to permit a player to specify and maintain multiple avatar profiles for the character associated with a player account for the player, and to permit the character to switch between these multiple avatar profiles during gameplay. Exemplary embodiments can permit rules-based mechanisms and/or genetic algorithms to be implemented within a metaverse application to provide for switching between multiple avatar profiles during gameplay.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a block diagram illustrating an exemplary embodiment of a client/server system that can be used to implement a metaverse application.

FIG. 2 is a screen shot illustrating one example of a player profile menu taken from the Second Life virtual community.

FIG. 3 is a block diagram illustrating an exemplary embodiment of a computer system.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

Massive multi-player online games (MMOGs), Massive Multi-Player Online Video Games (MMPOVGs), and massive multi-player role-playing games (MMORPGs) are computer games that are capable of supporting hundreds, thousands, or millions of user players simultaneously. These types of games include virtual video game worlds and virtual communities that are provided by a client/server system that includes a central game server that is commonly accessed by each user or player through a game console connected via a network such as an Internet or Intranet to the central game server. As such, multiple players are able to interact with each other as well as the virtual environment by accessing the central video game server via their game consoles. Alternatively, the virtual video game worlds or virtual communities can be provided by a distributed system such as a peer-to-peer network that includes at least two player consoles. Typically, these types of games are played in large grids that are implemented as persistent virtual worlds in which the game continues playing regardless of when, where, and whether each user is logged in. Users may be required to purchase additional software or hardware in order to play the game. Such networks can allow for people all over the world to participate and interact with each other in a virtual environment.

Exemplary embodiments of the present invention can be implemented to provide methods and systems that are suitable for use in a metaverse that provides a three-dimensional virtual world. As used herein, the term “virtual” as used herein can refer to the concept of “in a computer-generated environment or other intangible space.” Furthermore, the term “metaverse” as used herein can refer to a collection of online virtual environments which are accessible to one or more players of one or more online games or communities. The terms “virtual environment,” “game environment” and the like as used herein can refer to a region, sub-region or area of a metaverse such as a country, city, era, building, etc., which is in some way recognizably different from another region, sub-region, or area provided in the metaverse. In exemplary embodiments, certain areas provided in a metaverse may be restricted to some players. Examples of applications providing metaverse virtual environments include MMPOVGs such as World of Warcraft and virtual communities such as Second Life. As stated above, a particular metaverse may include one or more virtual or game environments.

In exemplary embodiments, the virtual or game environments and metaverses in which these environments take place are typically accessible to player via a game console. The term “game console” as used herein can refer to devices comprising a CPU, memory, and optional permanent storage residing at a player location that can allow for the playing of virtual games. Examples include, home PCs, Microsoft Xbox, Sony Playstation, Nintendo Wii, Playstation portable, etc. Dedicated video game consoles may be useful for only playing video games, while multifunctional video game consoles, such as personal computers, personal digital assistants (PDAs), and the like may be useful for performing multiple tasks including, but not limited to playing video games.

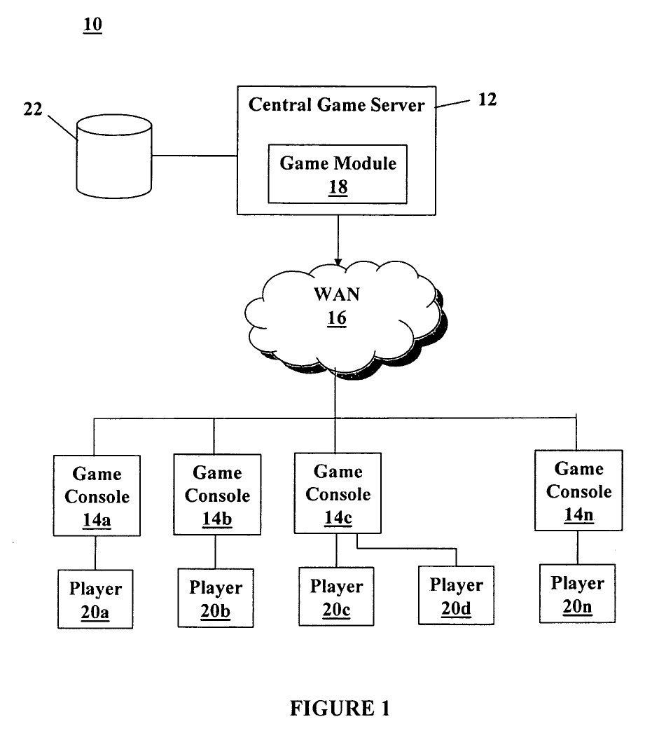

Referring now to FIG. 1, an exemplary embodiment of a client/server system 10 that can be used to implement a metaverse application providing a three-dimensional virtual world is illustrated. Metaverse system 10 includes a central game server 12 in communication with a plurality of client game consoles 14a, 14b, . . . , 14n via a wide are network (WAN) 16. Game consoles 14 are operated by user players 20a, 20b, . . . , 20n. In exemplary embodiments, central game server 12 may comprise any number of server components that operate to coordinate the activities of the game consoles 14. Furthermore, any number of game consoles 14 may be in communication with server 12. Typically, the number of game consoles 14 connected at any given time changes repeatedly as players join games and as players stop playing games. System 10 can be implemented using standard network and security protocols.

In exemplary embodiments, central game server 12 may comprise any computing device (for example, one or more computers) capable of communicating with other computing devices. Server 12 can comprise a processor that is in communication with a storage device, such as an appropriate combination of RAM, ROM, hard disk, and other well known storage media. Server 12 may comprise one or more personal computers, web servers, dedicated game servers, game consoles, any combination of the foregoing, or the like.

In exemplary embodiments, each game console 14 may comprise any device capable of communicating with central game server 12, providing gameplay information to a player, and transmitting the player's desired actions to the central game server. Each game console 14 can comprise a processor that is in communication with a storage device, such as an appropriate combination of RAM, ROM, hard disk, and other well known storage media. Suitable devices for game consoles 14 can include, but are not limited to, personal computers, video game consoles, mobile phones, and PDAs.

In the present exemplary embodiment, metaverse system 10 includes a metaverse application or game module 18 is stored on central game server 12. Game module 18 comprises software that runs continuously on server 12 to generate and persist the virtual world. Client software on game consoles 14 may provide access to the entire playing world (for example, by implementing a graphical viewer program module), or further “expansions” may be required to be purchased to allow access to certain virtual environments of the game. In alternative exemplary embodiments, some or all of game module 18 can be stored and/or run on server 12, and some or all of game module 18 may be stored on individual game consoles 14. Regardless of the storage implementation for game module 18, server 12 can be configured to facilitate play of the game module by multiple players 14 concurrently. Server 12 and game module 18 can be configured to handle and verify a large number of connections, prevent cheating, and apply changes (for example, bug fixes or added content) to the game. Server 12 and game module 18 can be configured to provide a system for recording gameplay data at regular intervals without stopping gameplay.

In exemplary embodiments, game consoles 14 are able to communicate with one another over WAN 16, and such communication may be facilitated by server 12. For example, player 20a accessing game module 18 via game console 14a may be able to interact with a player 20b accessing the game module via game console 14b. In exemplary embodiments, as illustrated in FIG. 1, it may be possible for multiple players (for example, 20c, 20d in FIG. 1) to access server 12 via the same game console (for example, 14c in FIG. 1).

It should be understood that the term “game” as used herein need not refer to a game in the traditional sense of a competition in which a winner and/or loser is determined, but rather that the term “game” can incorporate the idea of a metaverse regardless of the intended purpose. For example, both World of Warcraft and Second Life can be referred to as games for the purposes of the present disclosure. Moreover, a person or entity who logs in to a metaverse to, for example, conduct business, tour a metaverse, or simply interact with others or the virtual environment provided by a metaverse, with or without the purpose of competing against another entity, can still be described as “playing the game.” Furthermore, the term “player” as used herein can refer to any entity that accesses the metaverse, regardless of whether the player intends to or is capable of competing against other players. In exemplary embodiments, a player can register an account with central game server 12 and then create and/or control characters that can interact with the virtual world and with other characters created by other players in the virtual world provided by game module 20. The term “character” as used herein can refer to a persona created by a player in a metaverse, while the term “avatar” as used herein can refer to the appearance or representation (for example, physical embodiment) and other characteristics of a character in the metaverse. An avatar may be take a humanoid or a wide variety of other form in appearance, be of either sex, have a wide range of physical attributes, and be clothed or otherwise customized.

In exemplary embodiments, central game server 12 may be configured to maintain, host, and/or otherwise be in communication with a player account for each player that accesses game module 18. A player account includes information related to a particular player. Accordingly, a player account may be a program and/or database that tracks various player related data including, but not necessarily limited to, player ID, player billing info, player character ID, character attributes, which may include any quality, trait, feature, or characteristic a particular character can have. In exemplary embodiments, player related data such as character attributes may or may not change during a character's life. As used herein, the term “character life” can refer to the fixed period of virtual or real world time that a player character can exist in a virtual environment. In the present exemplary embodiment, the player related data for player accounts is stored on and accessed from a player database 22 in communication with central game server 12. In alternative exemplary embodiments, some or all of the player related data can be stored on a database in communication with server 12, and some or all of the player related data may be stored on a database in communication with individual game consoles 14. For example, some or all of the player related data for player 20a can be stored on game console 14a.

In exemplary embodiments, players can be required to specify an avatar profile for a character when they create a player account. An avatar profile includes information about the player's avatar or avatar attributes such as, for example, name, interests, appearance, relationships, etc. Avatar attributes may be stored in player database 22 using exemplary fields such as attribute ID, attribute type, attribute descriptor, and attribute value. The attribute ID field can be used to identify the character attribute. The attribute type field can specify what kind of attribute it is. The attribute descriptor field can be a word, phrase, or alphanumerical term to describe the attribute, an arbitrary code, or a search parameter. The attribute value field can be the value of the character attribute.

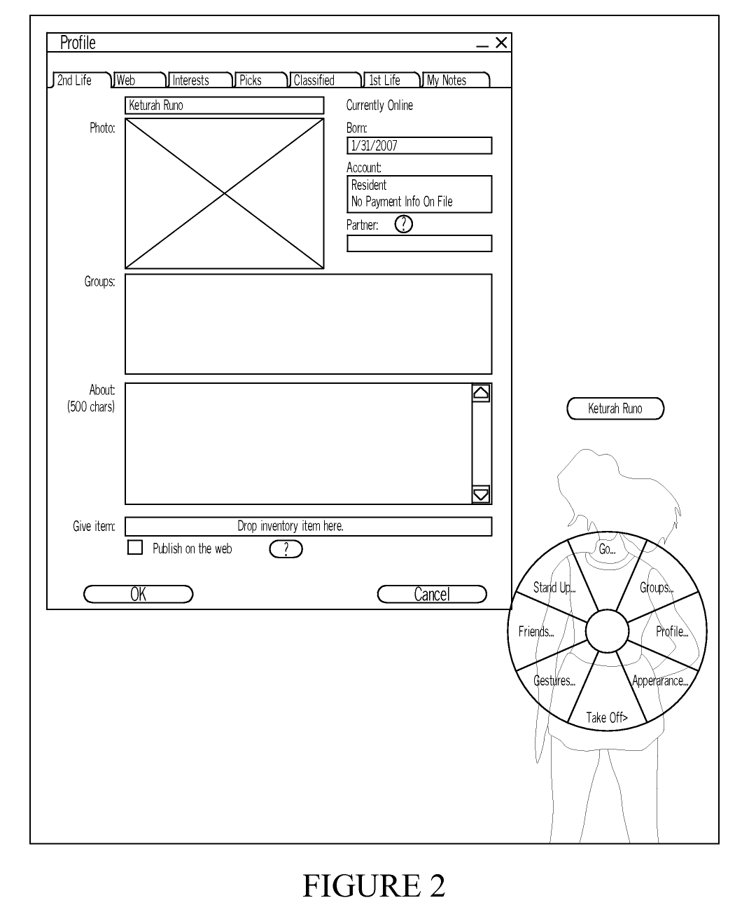

In exemplary embodiments, a player can customize, modify, add additional items or options to, and remove items or options from the avatar profile as needed. Other customization options can include, for example, avatar attributes for hair, accessories, eyes, eyebrows, and clothing (for example, shirts, sleeves, pants, and shoes). In exemplary embodiments, game module 18 can be configured to provide an option for that allows players to bring up a GUI menu screen or other control for viewing and editing avatar attributes in their avatar profiles. FIG. 2 illustrates one example of such a player profile menu in a screen shot taken from the Second Life virtual community. In exemplary embodiments, metaverse system 10 can be configured to allow avatar profile information to be exchanged between players. For example, in Second Life, while a first player's avatar is touching a second player's avatar during gameplay, each player is able get an indication of the interests of the other player's avatar from their profile.

In accordance with exemplary embodiments of the present invention, metaverse system 10 can be configured to permit a player to specify and maintain multiple avatar profiles for the character associated with a player account for the player, and to permit the character to switch between these multiple avatar profiles during gameplay (that is, while playing in the virtual environment provided by game module 18). Thus, rather than incrementally modifying single attributes of a unitary and fixed avatar profile to alter the representation of a player's character, a character can be directly switched between multiple, possibly very different profiles in a manner that can involve a change of multiple avatar attributes for the character concurrently. A switch from one avatar profile to another can involve a change of any or all avatar attributes provided for in avatar profiles such as, for example, name, like and dislikes, relationships, hair, accessories, eyes, eyebrows, clothing, etc.

For example, a player may desire to maintain multiple profiles to allow the player to change they way their character is perceived by others when their character encounters different situations or circumstances, or takes different actions, in the virtual environment. In a more specific example, a player may desire to maintain a “professional” avatar profile for when the player's character attends a business event in the virtual environment, a “club member” avatar profile that allows other players to identify them as a member of a club for when the player's character attends a club meeting, and a “casual” avatar profile for when the player's character attends a social function that doesn't warrant a professional, business, or other association. In exemplary embodiments, a player can purchase the right to specify multiple avatar profiles and/or rights to switch between multiple avatar profiles during gameplay. These rights could be bought, for example, for a one-time fee, for a period of time, for a certain number of uses, or until a certain event occurs or stops occurring.

In exemplary embodiments, rules-based mechanisms and/or genetic algorithms can be implemented within game module 18 to provide for switching between multiple avatar profiles associated with their player account. As used herein, the term “genetic algorithm” may include any software application or module that can improve results with use. A genetic algorithm generally involves a search technique to find exact or approximate solutions to optimization and search problems such as, for example, timetabling, scheduling, and global optimization problems. Various uses and applications of rules-based, expert systems, and/or genetic algorithms are well known and may be implemented using any applicable means.

In an exemplary embodiment, a rules-based mechanism can be implemented as a software application, agent, or module within game module 18 that allows a player to specify a set of rules that govern switching between multiple avatar profiles maintained by the player. As a result, a player, while playing as a character in a metaverse provided by a game module implementing such a mechanism, could be able to create a number of different avatar profiles for the player's character that each reflect a different intended use of the player's character, and then the player could specify a set of rules that govern switching between said profiles using the rules-based mechanism. In exemplary embodiments, game module 18 could also be configured to offer a set of default rule sets or options which a player may select from and/or customize. In exemplary embodiments, such sets of rules could be stored in and accessed from player database 22.

In exemplary embodiments, the specified or otherwise provided rules governing switching between multiple avatar profiles may be related to actions taken by players, actions taken by a player's character, or events that transpire in the virtual environment. Examples of types of rules that may be specified or provided can include rules that allow a player to switch between avatar profiles when upon logging in to game module 18, allow a player to switch between avatar profiles during real-time gameplay at any time or specified times, instruct the avatar profile to be switched based on a change in the character's location (for example, a character could switch to an “employee” avatar profile upon arriving at a work location), instruct a player's avatar profile to be switched based upon on other characters or the avatar profiles of other characters within a specified proximity or a vicinity of the player's character (for example, a character could switch to a “business” avatar profile when a business associate is nearby), instruct a player's avatar profile to be switched based upon an action taken by the player's character or other characters, instruct a player's avatar profile to be switched based upon the time duration a player is logged in to the game module, and instruct a player's avatar profile to be switched based upon the level of interaction the player with the virtual environment.

In exemplary embodiments, an algorithm could be incorporated to determine how to handle multiple dependencies that arise when using a specified or provided set of avatar profile-switching rules. In exemplary embodiments, one or more genetic algorithms can be implemented within game module 18 for governing switching between multiple avatar profiles that can take as inputs an initial set of rules specified by the player maintaining the multiple user profiles and feedback (for example, positive or negative) provided by the player regarding the actual avatar profile switching that has occurred during gameplay.

In exemplary embodiments, the rules-based mechanism and/or genetic algorithm could be configured to be incorporated within either game module 18 and/or game consoles 14 as a plug-in or extension supported by the game module or game consoles. As used herein, the term “plug-in” can refer is a software application or module program, or one or more computer instructions, which may or may not be in communication with other software applications or modules, that interacts with a host application to provide specified functionality, and which may include any file, image, graphic, icon, audio, video, or any other attachment.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

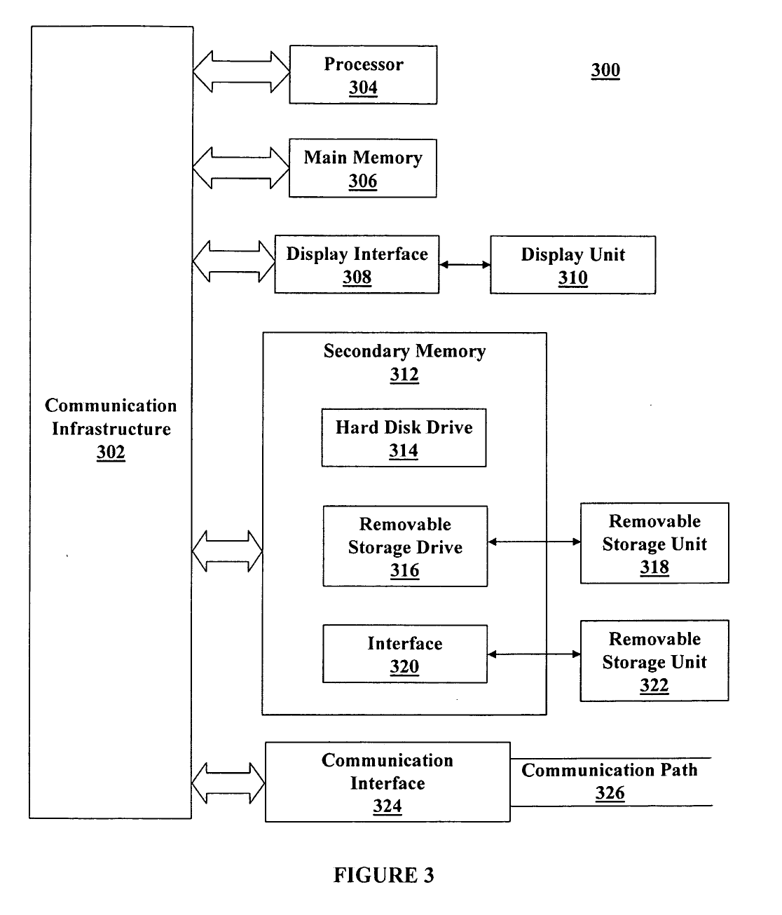

FIG. 3 is a block diagram of an exemplary computer system 300 that can be used for implementing exemplary embodiments of the present invention. Computer system 300 includes one or more processors, such as processor 304. Processor 304 is connected to a communication infrastructure 302 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 300 can include a display interface 308 that forwards graphics, text, and other data from the communication infrastructure 302 (or from a frame buffer not shown) for display on a display unit 310. Computer system 300 also includes a main memory 306, which can be random access memory (RAM), and may also include a secondary memory 312. Secondary memory 312 may include, for example, a hard disk drive 314 and/or a removable storage drive 316, representing a floppy disk drive, a magnetic tape drive, an optical disk drive, etc. Removable storage drive 316 reads from and/or writes to a removable storage unit 318 in a manner well known to those having ordinary skill in the art. Removable storage unit 318, represents, for example, a floppy disk, magnetic tape, optical disk, etc. which is read by and written to by removable storage drive 316. As will be appreciated, removable storage unit 318 includes a computer usable storage medium having stored therein computer software and/or data.

In exemplary embodiments, secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. These signals are provided to communications interface 324 via a communications path (that is, channel) 326. Channel 326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 306 and secondary memory 312, removable storage drive 316, a hard disk installed in hard disk drive 314, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 306 and/or secondary memory 312. Computer programs may also be received via communications interface 324. Such computer programs, when executed, can enable the computer system to perform the features of exemplary embodiments of the present invention as discussed herein. In particular, the computer programs, when executed, enable processor 304 to perform the features of computer system 300. Accordingly, such computer programs represent controllers of the computer system.

Although exemplary embodiments of the present invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A method for providing gameplay in a metaverse application in which players interact with each other and a virtual world by controlling characters that are represented using avatars specified by avatar profiles, the method comprising:
providing a player with an ability to specify and maintain more than one avatar profile for a character controlled by the player; and
allowing an avatar representation of the character to be switched between the more than one avatar profile during gameplay.

2. The method of claim 1, further comprising maintaining a set of rules that specify a set of events that may occur and stipulate which of the more than one avatar profile the avatar representation of the character should be switched to in response to each of the events occurring, and switching the avatar representation of the character between the more than one avatar profile based upon the set of rules.

3. The method of claim 2, further comprising providing a default set of rules as the set of rules, and allowing the player to modify the default set of rules or specify a new set of rules to replace the default set of rules as the set of rules.

4. The method of claim 2, wherein the set of events includes events selected from actions taken by the player, actions taken by the character associated with the player, actions taken by characters controlled by other players of the metaverse application, and events that transpire in the virtual world.

5. The method of claim 1, wherein the metaverse application is provided by a central game server that is in communication with a plurality of game consoles via a network, the game consoles being operated by a plurality of players controlling characters in the virtual world.

6. The method of claim 5, wherein a player account for the player is maintained in a database accessible by the central game server, and wherein each of the more than one avatar profiles is maintained in the player account as a set of avatar attributes.
